(19) United States
(12) Patent Application Publication
(10) Pub. No.: US 2025/0337560 A1
(43) Pub. Date: Oct. 30, 2025

(54) METHOD FOR PROCESSING HOMOMORPHIC CIPHERTEXT AND ELECTRONIC APPARATUS

(71) Applicant: CRYPTO LAB INC., Seoul (KR)

(72) Inventors: Youngjin Bae, Seoul (KR); Jaehyung Kim, Stanford, CA (US)

(21) Appl. No.: 19/184,505

(22) Filed: Apr. 21, 2025

(30) Foreign Application Priority Data
Apr. 24, 2024 (KR) 10-2024-0054961
Apr. 24, 2024 (KR) 10-2024-0054972
Apr. 24, 2024 (KR) 10-2024-0054995
Mar. 12, 2025 (KR) 10-2025-0031857

(51) Int. Cl. H04L 9/00

(52) U.S. Cl. CPC H04L 9/008

(57) ABSTRACT

An electronic apparatus includes: a memory for storing an instruction; and a processor configured to execute the instruction to thus transform a first homomorphic ciphertext homomorphically encrypted using a first scheme into a second homomorphic ciphertext encrypted using a second scheme, wherein each of the first homomorphic ciphertext and the second homomorphic ciphertext includes an a-part and a b-part, the first scheme is a homomorphic ciphertext format in which a plurality of homomorphic ciphertexts have different a-parts and b-parts, the second scheme is a homomorphic ciphertext format in which a plurality of homomorphic ciphertexts have the same a-part and only different b-parts, and the processor is configured to transform the first homomorphic ciphertext into the second homomorphic ciphertext by iterating a partial transformation operation of gradually increasing a rank of a secret key multiple times.

### CROSS-REFERENCE TO RELATED APPLICATION(S)

This application is based on and claims priority under 35 U.S.C. § 119 to Korean Patent Application No. 10-2025-0031857, filed on Mar. 12, 2025, in the Korean Intellectual Property Office, which claims priority under 35 U. S. C. § 119 to Korean Patent Application No. 10-2024-0054961, filed on Apr. 24, 2024, which claims priority under 35 U. S. C. § 119 to Korean Patent Application No. 10-2024-0054972, filed on Apr. 24, 2024, which claims priority under 35 U. S. C. § 119 to Korean Patent Application No. 10-2024-0054995, filed on Apr. 24, 2024, the disclosure of which is incorporated by reference herein in its entirety.

### BACKGROUND

### Field

Apparatuses and methods consistent with the disclosure relate to a method for processing a homomorphic ciphertext and an electronic apparatus to reduce a size of the ciphertext.

### Description of the Related Art

As communication technology advances and electronic apparatuses become more widespread, continuous efforts are being made to ensure secure communication between the electronic apparatuses. Accordingly, encryption and decryption technology are used in most communication environments.

If a message encrypted by the encryption technology is transmitted to the other party, the other party is required to perform decryption to use the message. In this case, the other party may waste resources and time in a process of decrypting encrypted data. In addition, the message may easily be leaked to a third party if the third party hacks the message while the other party temporarily decrypts the message for operation.

To solve these problems, homomorphic encryption methods are being studied. Homomorphic encryption may acquire the same result as an encrypted value acquired after performing an operation on a plaintext, even if the operation is performed on a ciphertext itself acquired without decrypting encrypted information. Therefore, various operations may be performed without decrypting the ciphertext.

Such a homomorphic ciphertext (encrypted data by homomorphic encryption) may have a much larger size than a plaintext. If a large amount of data is stored in a homomorphically encrypted form in an environment such as a database (DB), a large storage space may be required. Accordingly, there is a need for a method for storing the data in a homomorphic ciphertext form to reduce its size compared to a conventional case.

### SUMMARY

An embodiment of the disclosure may solve at least one of the problems and/or disadvantages described above and provide advantages described below. Accordingly, the disclosure provides an electronic apparatus and a method for processing the homomorphic ciphertext to reduce a size of a ciphertext.

The disclosure also provides a method for processing a homomorphic ciphertext and an electronic apparatus to reduce a size of the ciphertext.

Additional embodiments will be described in the detailed description provided below. Some will be apparent from the detailed description, while others will be derived through learning from the described embodiments.

According to an embodiment of the disclosure, provided is an electronic apparatus including: a memory for storing an instruction; and a processor configured to execute the instruction to thus transform a first homomorphic ciphertext homomorphically encrypted using a first scheme into a second homomorphic ciphertext encrypted using a second scheme, wherein each of the first homomorphic ciphertext and the second homomorphic ciphertext includes an a-part and a b-part, the first scheme is a homomorphic ciphertext format in which a plurality of homomorphic ciphertexts have different a-parts and b-parts, the second scheme is a homomorphic ciphertext format in which a plurality of homomorphic ciphertexts have the same a-part and only different b-parts, and the processor is configured to transform the first homomorphic ciphertext into the second homomorphic ciphertext by iterating a partial transformation operation of gradually increasing a rank of a secret key multiple times.

The processor may be configured to transform the plurality of first homomorphic ciphertexts into one second homomorphic ciphertext.

The processor may be configured to generate a fourth homomorphic ciphertext encrypted using the second scheme, in which some of the plurality of first homomorphic ciphertexts have the same a-part, generate a fifth homomorphic ciphertext encrypted using the second scheme, in which the others of the plurality of first homomorphic ciphertexts have the same a-part, determine the a-part of the second homomorphic ciphertext by using the a-part of the fourth homomorphic ciphertext and the a-part of the fifth homomorphic ciphertext, and generate the b-part of the second homomorphic ciphertext based on the determined a-part of the second homomorphic ciphertext.

The partial transformation operation may be a partial merging operation for merging k homomorphic ciphertexts into one homomorphic ciphertext, and the processor may be configured to generate the one second homomorphic ciphertext from the plurality of first homomorphic ciphertexts by iterating the partial merging operation for increasing a rank of the merged homomorphic ciphertext by k times multiple times.

The processor may be configured to transform one first homomorphic ciphertext into one second homomorphic ciphertext, and a dimension of the a-part of the second homomorphic ciphertext may be smaller than a dimension of the a-part of the first homomorphic ciphertext.

The processor may be configured to expand a modulus of the homomorphic ciphertext, perform a first linear transformation on the homomorphic ciphertext, whose modulus is expanded, into a polynomial form, perform an approximate operation on the homomorphic ciphertext transformed into the polynomial form by using a function set to approximate a modulated range of a plaintext, and perform a second linear transformation on the homomorphic ciphertext, on which the approximate operation is performed, into a form of the homomorphic ciphertext to perform bootstrapping on the homomorphic ciphertext.

The processor may be configured to perform a modulus expansion operation on the homomorphic ciphertext whose modulus is expanded in the first linear transformation process for the first homomorphic ciphertext, and omit the modulus expansion operation from the first linear transformation process for the second homomorphic ciphertext.

The processor may be configured to perform the modulus expansion operation on the a-part of the second homomorphic ciphertext before performing matrix multiplication, and perform the modulus expansion operation on the b-part of the second homomorphic ciphertext after performing the matrix multiplication.

According to an embodiment of the disclosure, provided is a method for processing a ciphertext by an electronic apparatus, the method including: storing a first homomorphic ciphertext homomorphically encrypted using a first scheme; and transforming the first homomorphic ciphertext into a second homomorphic ciphertext encrypted using a second scheme, wherein each of the first homomorphic ciphertext and the second homomorphic ciphertext includes an a-part and a b-part, the first scheme is a homomorphic ciphertext format in which a plurality of homomorphic ciphertexts have different a-parts and b-parts, the second scheme is a homomorphic ciphertext format in which a plurality of homomorphic ciphertexts have the same a-part and only different b-parts, and in the transforming, the first homomorphic ciphertext is transformed into the second homomorphic ciphertext by iterating a partial transformation operation of gradually increasing a rank of a secret key multiple times.

In the transforming, the plurality of first homomorphic ciphertexts may be transformed into one second homomorphic ciphertext.

The transforming may include generating a fourth homomorphic ciphertext encrypted using the second scheme, in which some of the plurality of first homomorphic ciphertexts have the same a-part, and generating a fifth homomorphic ciphertext encrypted using the second scheme, in which the others of the plurality of first homomorphic ciphertexts have the same a-part, and determining the a-part of the second homomorphic ciphertext by using the a-part of the fourth homomorphic ciphertext and the a-part of the fifth homomorphic ciphertext, and generating the b-part of the second homomorphic ciphertext based on the determined a-part of the second homomorphic ciphertext.

The partial transformation operation may be a partial merging operation for merging k homomorphic ciphertexts into one homomorphic ciphertext, and in the transforming, the one second homomorphic ciphertext may be generated from the plurality of first homomorphic ciphertexts by iterating the partial merging operation for increasing a rank of the merged homomorphic ciphertext by k times multiple times.

In the transforming, one first homomorphic ciphertext may be transformed into one second homomorphic ciphertext, and a dimension of the a-part of the second homomorphic ciphertext may be smaller than a dimension of the a-part of the first homomorphic ciphertext.

The method may further include: expanding a modulus of the homomorphic ciphertext; performing a first linear transformation on the homomorphic ciphertext, whose modulus is expanded, into a polynomial form; performing an approximate operation on the homomorphic ciphertext transformed into the polynomial form by using a function set to approximate a modulated range of a plaintext; and performing a second linear transformation on the homomorphic ciphertext, on which the approximate operation is performed, into a form of the homomorphic ciphertext.

In the performing of the first linear transformation, a modulus expansion operation on the homomorphic ciphertext whose modulus is expanded may be performed for the first homomorphic ciphertext, and the modulus expansion operation may be omitted for the second homomorphic ciphertext.

In the expanding of the modulus, the modulus expansion operation may be performed on the a-part of the second homomorphic ciphertext before matrix multiplication, and the modulus expansion operation may be performed on the b-part of the second homomorphic ciphertext after the matrix multiplication.

According to an embodiment of the disclosure, provided is a non-transitory computer-readable recording medium including a program for executing a method for processing a ciphertext, wherein the method includes storing a first homomorphic ciphertext homomorphically encrypted using a first scheme, and transforming the first homomorphic ciphertext into a second homomorphic ciphertext encrypted using a second scheme, wherein each of the first homomorphic ciphertext and the second homomorphic ciphertext includes an a-part and a b-part, the first scheme is a homomorphic ciphertext format in which a plurality of homomorphic ciphertexts have different a-parts and b-parts, the second scheme is a homomorphic ciphertext format in which a plurality of homomorphic ciphertexts have the same a-part and only different b-parts, and in the transforming, the first homomorphic ciphertext is transformed into the second homomorphic ciphertext by iterating a partial transformation operation of gradually increasing a rank of a secret key multiple times.

### BRIEF DESCRIPTION OF THE DRAWINGS

The above and/or other aspects of the disclosure are more apparent by describing certain embodiments of the disclosure with reference to the accompanying drawings, in which:

FIG. 1 is a diagram for describing a structure of a network system according to an embodiment of the disclosure;

FIG. 2 is a block diagram showing a brief configuration of an electronic apparatus according to an embodiment of the disclosure;

FIG. 3 is a block diagram showing a specific configuration of the electronic apparatus according to an embodiment of the disclosure;

FIG. 4 is a diagram for describing the generation and decryption operations of an approximate homomorphic ciphertext;

FIG. 5 is a diagram for describing a bootstrapping operation in the disclosure;

FIG. 6 is a diagram for describing a detailed operation of the bootstrapping operation;

FIG. 7 is a flowchart for describing a method for processing a ciphertext according to an embodiment of the disclosure; and

FIG. 8 is a flowchart for describing the bootstrapping operation according to an embodiment of the disclosure.

### DETAILED DESCRIPTION

Hereinafter, the disclosure is described in detail with reference to the accompanying drawings. Encryption/decryption may be applied as necessary to a process of transmitting information (or data) that is performed in the disclosure, and an expression describing the process of transmitting the information (or data) in the disclosure and the claims should be interpreted as including all cases of the encryption/decryption even if not separately mentioned. In the disclosure, an expression such as “transmission (transfer) from A to B” or “reception from A to B” may include transmission (transfer) or reception while having another medium included in the middle, and may not necessarily express only the direct transmission (transfer) or reception from A to B.

In describing the disclosure, a sequence of each step should be understood as non-restrictive unless a preceding step in the sequence of each step needs to precede a subsequent step logically and temporally. That is, except for the above exceptional case, the essence of the disclosure is not affected even if a process described as the subsequent step is performed before a process described as the preceding step, and the scope of the disclosure should also be defined regardless of the sequences of the steps. In addition, in this specification, “A or B” may be defined to indicate not only selectively indicating either A or B, but also including both A and B. In addition, a term “including” in the disclosure may encompass a concept of further including other components in addition to components listed as being included.

The disclosure only describes essential components necessary for describing the disclosure, and does not mention components unrelated to the essence of the disclosure. In addition, it should not be interpreted as an exclusive concept that the disclosure includes only the mentioned components, and should be interpreted as a non-exclusive concept that the disclosure may include other components as well.

In addition, in the disclosure, a “value” may be defined as a concept that includes a vector as well as a scalar value. In addition, in the disclosure, an expression such as “calculate” or “compute” may be replaced with an expression that generates a result of the corresponding calculation or computation. In addition, unless otherwise indicated, an operation on a ciphertext described below refers to a homomorphic operation. For example, addition on the homomorphic ciphertexts indicates homomorphic addition on two homomorphic ciphertexts.

Mathematical operations and calculations in each step of the disclosure described below may be implemented as computer operations by a known coding method and/or coding designed to be appropriate for the disclosure to perform the corresponding operations or calculations.

Specific equations described below are illustratively provided among possible alternatives, and the scope of the disclosure should not be construed as being limited to the equations mentioned in the disclosure.

For convenience of description, the disclosure defines the following notations.
a←D: Select an element a based on distribution D.
s1, s2∈R: Each of s₁ and s₂ is an element belonging to a set R.

mod(q): Perform a modular operation with an element q.
└·┐: Round an internal value.

Hereinafter, various embodiments of the disclosure are described in detail with reference to the accompanying drawings.

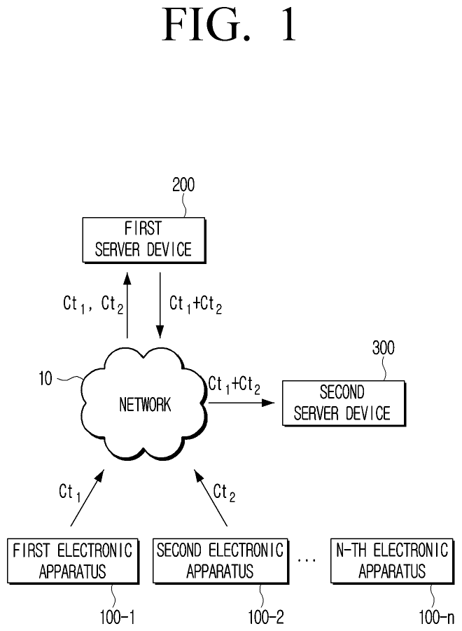

FIG. 1 is a diagram for describing a structure of a network system according to an embodiment of the disclosure.

Referring to FIG. 1, the network system may include a plurality of electronic apparatuses 100-1 to 100-n, a first server device 200, and a second server device 300, and the respective components may be connected to each other via a network 10.

The network 10 may be implemented as any of various forms of wired/wireless communication networks, a broadcast communication network, an optical communication network, a cloud communication network or the like, and the respective devices may be connected to each other without a separate medium, such as wireless fidelity (Wi-Fi), Bluetooth, or Near Field Communication (NFC).

FIG. 1 shows that the plurality of electronic apparatuses are provided. However, the plurality of electronic apparatuses are not necessarily required to be used, and a single apparatus may be used instead. As an example, the electronic apparatuses 100-1 to 100-n may be implemented in various forms of apparatuses such as smartphones, tablets, game players, personal computers (PCs), laptop PCs, home servers, or kiosks, and may also be implemented in the form of home appliances using Internet of Things (IoT) functions.

A user may input various information by using the electronic apparatuses 100-1 to 100-n that the user uses. The input information may be stored in the electronic apparatuses 100-1 to 100-n themselves, or may also be transmitted to and stored in an external device for reasons such as storage capacity and security. As shown in FIG. 1, the first server device 200 may serve to store such information, and the second server device 300 may serve to utilize some or all of the information stored in the first server device 200.

Each of the electronic apparatuses 100-1 to 100-n may homomorphically encrypt the input information and transmit a homomorphic ciphertext to the first server device 200. Here, a homomorphic encryption target may be text or speech used in a language model. Such text or speech may be separated into token units used in the language model, and homomorphically encrypted for each separated unit and provided to the first server device 200.

Each of the electronic apparatuses 100-1 to 100-n may include an error, i.e., encryption noise calculated in a process of performing homomorphic encryption, in the ciphertext. In detail, the homomorphic ciphertext generated by each of the electronic apparatuses 100-1 to 100-n may be generated in a form in which a result value including a message and an error value is restored if the homomorphic ciphertext is decrypted later utilizing a secret key.

As an example, the homomorphic ciphertext generated by each of the electronic apparatuses 100-1 to 100-n may be generated in a form that satisfies the following property (shown in Equation 1) if decrypted utilizing the secret key.

$$Dec ( ct , sk ) = 〈 ct , sk 〉 = M + e ( mod q ) . \qquad [ Equation 1 ]$$

Here, < and > indicate dot product operation (or usual inner product), ct indicates the ciphertext, sk indicates the secret key, M indicates a plaintext message, e indicates the encryption error value, and mod q indicates a modulus of the ciphertext. q needs to be selected to be larger than a result value M multiplied by a scaling factor Δ to the message. If an absolute value of an error value e is sufficiently smaller than M, a decrypted value M+e of the ciphertext may be a value that may replace an original message by the same precision in a significant figure operation. Among decrypted data, the error may be disposed on the least significant bit (LSB) side, and M may be disposed on the next least significant bit side.

If a size of the message is too small or too large, the size may be adjusted using the scaling factor. If the scaling factor is used, not only a message in an integer form but also a message in a real number form may be encrypted, and its usability may thus be greatly increased. In addition, the size of the message may be adjusted utilizing the scaling factor to thus also adjust a size of an effective region, that is, a region where the messages exist in the ciphertext after the operation is performed.

In some embodiments, the modulus q of the ciphertext may be set and used in various forms. As an example, the modulus of the ciphertext may be set in a form of an exponential power q=Δ^{L} of the scaling factor Δ. If Δ is 2, the modulus may be set to a value such as q=2¹⁰.

Meanwhile, the homomorphic ciphertext generated by an electronic apparatus 100 according to the disclosure may be a ciphertext acquired using a learning with errors (LWE) scheme. In detail, this type of ciphertext is intended to save communication resources during a transmission process of the generated ciphertext, and in implementation, the ciphertext may be generated using a module learning with errors (MLWE) scheme or a ring learning with errors (RLWE) scheme instead of the LWE scheme. In addition, in the disclosure, the homomorphic ciphertext may be generated using a method for generating only some components (information) included in the ciphertext instead of the general LWE or RLWE scheme.

The LWE scheme may be referred to as a single message homomorphic encryption scheme, single message homomorphic encryption, or the like. The RLWE scheme is a homomorphic encryption scheme that has a plurality of slots and may include the message in each slot, and may be referred to as multiple message homomorphic encryption, Cheon-Kim-Kim-Song (CKKS) homomorphic encryption, or the like. The MLWE scheme is a homomorphic encryption scheme that generalizes the LWE or RLWE scheme described above. In this respect, the LWE scheme may be viewed as an MLWE scheme having rank k and dimension 1. That is, LWE^{k}=MLWE^{k}₁. The RLWE scheme may be viewed as an MLWE scheme that has rank 1 and dimension N. That is, RLWE_{N}=MLWE¹_{N}.

Hereinafter, for ease of description, the following description targets the above-described RLWM ciphertext, and may also target the LWE ciphertext or the MLWE ciphertext.

Meanwhile, the disclosure describes a method of compressing and storing the above-described ciphertext. Accordingly, the ciphertext before compression may be referred to as a first-scheme homomorphic ciphertext, and the ciphertext after compression may be referred to as a second-scheme homomorphic ciphertext.

This first-scheme homomorphic ciphertext refers to the RLWE ciphertext as described above, and may also refer to the LWE ciphertext or the MLWE ciphertext as described above. This first homomorphic ciphertext refers to a case where there is no restriction on an a-part or a b-part included in the homomorphic ciphertext.

Meanwhile, the second-scheme homomorphic ciphertext may be referred to as a multi-secret RLWE (MSRLWE) ciphertext having some restrictions on the a-part. This second-scheme homomorphic ciphertext may have the same a-part in case of including a plurality of homomorphic ciphertexts. In this respect, the second-scheme homomorphic ciphertext may be referred to as a shared-a format.

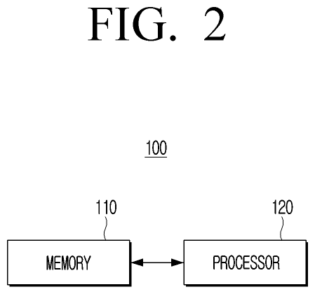

This transformation operation may be described in more detail with reference to FIG. 2.

The first server device 200 may store the received homomorphic ciphertext in a ciphertext state without decryption. Meanwhile, the first server device 200 may store not only the homomorphic ciphertext encrypted using one scheme, but also the homomorphic ciphertext encrypted using various schemes.

In this case, the first server device 200 may perform the transformation operation on the homomorphic ciphertext encrypted using different schemes, or perform a process of merging the plurality of homomorphic ciphertexts into one ciphertext.

The second server device 300 may request a specific processing result for the homomorphic ciphertext from the first server device 200. For example, the second server device 300 may request a matrix operation to be performed on the plurality of homomorphic ciphertexts. The matrix operation may be an inference process using a pre-trained learning model. Accordingly, the second server device 300 may provide the first server device 200 with a weight matrix included in the corresponding learning model.

The first server device 200 may perform a specific operation based on the request of the second server device 300 and then transmit its result to the second server device 300.

As an example, if ciphertexts ct1 and ct2 transmitted by two electronic apparatuses 100-1 and 100-2 are stored in the first server device 200, the second server device 300 may request, from the first server device 200, a value acquired by adding the information provided by the two electronic apparatuses 100-1 and 100-2. The first server device 200 may perform an operation to add the two ciphertexts based on the request and then transmit a result value ct1+ct2 to the second server device 300.

Due to a property of the homomorphic ciphertext, the first server device 200 may perform the operation without decryption, and may acquire a result value also in the form of a ciphertext. In the disclosure, the result value acquired by the operation is referred to as an operation result ciphertext.

The first server device 200 may transmit the operation result ciphertext to the second server device 300. The second server device 300 may decrypt the received operation result ciphertext and acquire an operation result value of the data included in each homomorphic ciphertext.

The first server device 200 may perform the operation multiple times based on a user request. In this case, an approximate message weight in the operation result ciphertext acquired for each operation may be different. The first server device 200 may perform a bootstrapping operation if the approximate message weight exceeds a threshold. In this way, the first server device 200 may perform operation processing and thus be referred to as an operation device.

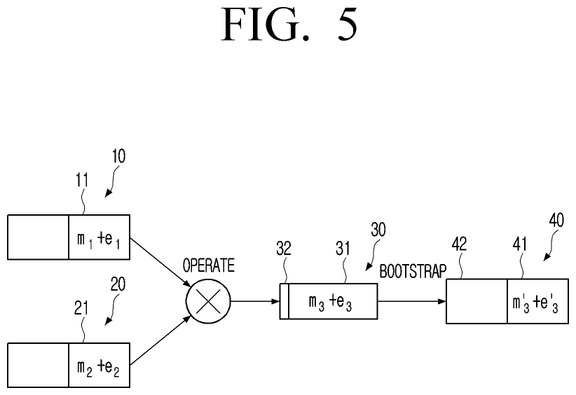

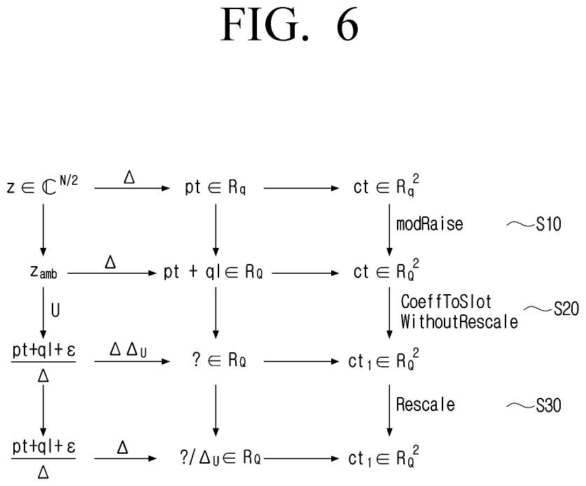

In detail, in Equation 1 above, the decryption becomes impossible because M+e (mod q) has a different value from M+e if q is smaller than M. Therefore, a value of q needs to always be maintained to be larger than M. However, as the operation progresses, the value of q gradually decreases. Therefore, an operation is required to change the value of q to always be larger than M, and this operation is referred to as the bootstrapping operation. As the bootstrapping operation is performed, the ciphertext may be available for the operation. Meanwhile, the bootstrapping operation may be performed in different ways depending on whether the homomorphic ciphertext is the first homomorphic ciphertext or the second homomorphic ciphertext. This configuration is described below with reference to FIGS. 5 and 6.

Meanwhile, FIG. 1 shows a case where the encryption may be performed by the first electronic apparatus and the second electronic apparatus, and the decryption may be performed by the second server, and the disclosure is not necessarily limited thereto.

FIG. 2 is a block diagram showing a brief configuration of an electronic apparatus according to an embodiment of the disclosure.

Referring to FIG. 2, the electronic apparatus 100 may include a memory 110 and a processor 120. The electronic apparatus shown in FIG. 2 may perform not only the function of the electronic apparatus in FIG. 1, but also the function of the server device in FIG. 1.

The memory 110 is a component for storing various instructions and/or software, data, or the like related to the generation and processing for operation of the homomorphic ciphertext described below or an operating system (O/S) for driving the electronic apparatus 100. The memory 110 may be implemented in any of various forms such as a random-access memory (RAM), a read-only memory (ROM), a flash memory, a hard disk drive (HDD), an external memory, or a memory card, and is not limited to any one thereof.

The memory 110 may store the message to be encrypted. Here, the message may include various credit information, personal information, or the like quoted by the user, and may also be information related to a usage history, such as location information, internet usage time information, or the like used by the electronic apparatus 100. Alternatively, the message may be text generated from speech spoken by the user or text generated via text-to-speech (TTS) from the speech described above.

In addition, the memory 110 may store a public key, and if the electronic apparatus 100 is an apparatus that directly generates the public key, the electronic apparatus 100 may store not only the secret key, but also various parameters necessary for generating the public key and the secret key.

In addition, the memory 110 may store the homomorphic ciphertext generated in a process described below (e.g., merged homomorphic ciphertext or homomorphic ciphertext generated using the homomorphic operation). Here, the ciphertext stored in the memory 110 may be a ciphertext generated using the RLWE scheme.

In addition, the memory 110 may store plaintext matrix data to be utilized in the ciphertext operation described below. This matrix data may be the weight matrix included in the language model described above. In addition, the memory 110 may store various data (e.g., second matrix ciphertext or third matrix ciphertext) temporarily generated in the process described below.

The processor 120 may control each component included in the electronic apparatus 100. The processor 120 may be configured as a single device, such as a central processing unit (CPU) or an application-specific integrated circuit (ASIC), or may be configured as a plurality of devices, such as central processing units (CPUs) and graphics processing units (GPUs).

The processor 120 may store the message to be transmitted in the memory 110 if the corresponding message is received. The processor 120 may homomorphically encrypt the message by utilizing various set values and programs stored in the memory 110. In this case, the public key may be used.

The processor 120 may generate and use the public key required to perform the encryption on its own, or may receive the public key from the external device and use the same. As an example, the second server device 300 performing the decryption may distribute the public key to other devices.

If the processor 120 generates the key on its own, the processor 120 may generate the public key by utilizing the Ring-LWE scheme. To describe in detail, the processor 120 may first set the various parameters and rings and store the same in the memory 110. An example of the parameter may include a length of plaintext message bits, dimension n, rank k, a size of the public key or the secret key, or the like. The homomorphic ciphertext may have various formats, and the processor 120 may set the ring based on a ciphertext scheme according to a scheme set by the user or a predetermined scheme. For example, the homomorphic ciphertext scheme described above may be the CKKS scheme or the RLWE scheme.

The ring may be expressed by the following equation.

$$R = {Z}_{q} [ X ] / f ( x ) . \qquad [ Equation 2 ]$$

Here, R indicates the ring, Z_{q} indicates a coefficient, and f(x) indicates an N-th polynomial.

The Ring indicates a set of polynomials having predetermined coefficients, and indicates the set in which addition and multiplication are defined between elements and which is closed under the addition and multiplication. The Ring may be referred to as the ring.

As an example, the ring indicates a set of the N-th polynomials having the coefficient Z_{q}. In detail, if n is Φ(N), N indicates a polynomial which may be calculated as the remainder of dividing the polynomial by an N-th cyclotomic polynomial. (f(x)) indicates ideal of Z_{q}[x] generated by f(x). The Euler totient function Φ(N) indicates the number of natural numbers that are coprime to N and smaller than N.

The ring used in the above-described MLWE may be expressed by Equation 3 below.

$${R}_{q , N} = {Z}_{q} [ {X}_{( N )} ] / ( {X}_{( N )}^{N} + 1 ) . \qquad [ Equation 3 ]$$

Here, q indicates a modulus, k indicates a rank, and N indicates a dimension. Meanwhile, the above-described ring assumes MLWE, and in case of using LWE, N may be replaced with 1 and used, and in the RLWE scheme, k may be replaced with 1 and used.

If the ring is set, the processor 120 may calculate a secret key sk from the ring.

$$sk ← ( 1 , s ( x ) ) , s ( x ) ∈ R . \qquad [ Equation 4 ]$$

Here, s(x) indicates a random polynomial generated using a small coefficient.

If the ring and the secret key are selected, the processor 120 may calculate a first random polynomial (a(x)) from the ring. The first random polynomial may be expressed as follows.

$$a ( x ) ← R . \qquad [ Equation 5 ]$$

In addition, the processor 120 may calculate the error. In detail, the processor 120 may extract the error from a discrete Gaussian distribution or a distribution having a statistical distance close thereto. This error may be expressed as follows.

$$e ( x ) ← {D}_{α q}^{n} . \qquad [ Equation 6 ]$$

If even the error is calculated, the processor 120 may calculate a second random polynomial by performing a modular operation on the error in the first random polynomial and the secret key. The second random polynomial may be expressed as follows.

$$b ( x ) = - a ( x ) s ( x ) + e ( x ) ( mod q ) . \qquad [ Equation 7 ]$$

Finally, a public key pk may be set to include the first random polynomial and the second random polynomial as follows.

$$p k = ( b ( x ) , a ( x ) ) . \qquad [ Equation 8 ]$$

Meanwhile, each content of Equations 4 to 8 described above may be an example of a case of using the CKKS scheme (i.e., RLWE scheme), and the above-described scheme may be modified to suit a corresponding scheme and used in case of using the LWE or MLWE scheme. In addition, the public key and the secret key may be generated using a scheme other than the scheme described above.

In addition, the processor 120 may generate the homomorphic ciphertext for the message. In detail, the processor 120 may generate the homomorphic ciphertext by applying a previously generated public key to the message.

If the processor 120 generates the plurality of homomorphic ciphertexts, the processor 120 may merge the plurality of homomorphic ciphertexts into one homomorphic ciphertext. Alternatively, the processor 120 may perform the operation described below on one homomorphic ciphertext to reduce the homomorphic ciphertext. The operation may be referred to as the compression of the homomorphic ciphertext or the transformation operation of the homomorphic ciphertext.

Hereinafter, the description describes the compression (or transformation) operation of the homomorphic ciphertext according to the disclosure.

First, the processor 120 may store the first homomorphic ciphertext homomorphically encrypted using a first scheme. Here, the first homomorphic ciphertext is a CKKS-scheme ciphertext, and this ciphertext may include the a-part and the b-part. For example, if the homomorphic ciphertext has the form of ct=(a, b)∈R²_{q,N}, the former component in the parentheses described above is the a-part, and the latter component in the parentheses is the b-part. The a-part and the b-part may be expressed as a plaintext for the above-described ciphertext, Dec(ct)=b+as=m.

In addition, the first-scheme homomorphic ciphertext may be a plurality of homomorphic ciphertexts, each of which has different values for the a-part and the b-part.

The processor 120 may transform the first homomorphic ciphertext into the second homomorphic ciphertext encrypted using a second scheme. For example, the processor 120 may transform the first homomorphic ciphertext into the second homomorphic ciphertext by iterating a partial transformation operation for gradually increasing a rank of the secret key multiple times.

The transformation may be classified into a first embodiment that transforms the plurality of first homomorphic ciphertexts into one second homomorphic ciphertext, and a second embodiment that transforms one first homomorphic ciphertext into the second homomorphic ciphertext.

First, in the first embodiment, the processor 120 may generate one second homomorphic ciphertext from the plurality of first homomorphic ciphertexts by iterating a partial merging operation for increasing a rank of the merged homomorphic ciphertext by k times multiple times. Here, the partial transformation operation may be the partial merging operation for merging k homomorphic ciphertexts into one homomorphic ciphertext.

For example, in case of using two-time iterations, the processor 120 may generate a fourth homomorphic ciphertext encrypted using the second scheme, in which some of the plurality of first homomorphic ciphertexts have the same a-part, and may generate a fifth homomorphic ciphertext encrypted using the second scheme, in which the others of the plurality of first homomorphic ciphertexts have the same a-part. In addition, the processor 120 may determine the a-part of the second homomorphic ciphertext by using the a-part of the fourth homomorphic ciphertext and the a-part of the fifth homomorphic ciphertext, and generate the b-part of the second homomorphic ciphertext based on the determined a-part of the second homomorphic ciphertext. Meanwhile, in the implementation, two or more repetitions may be used instead of two repetitions.

Meanwhile, in the second embodiment, the processor 120 may perform the partial merging operation described above in a process of transforming one first homomorphic ciphertext into one second homomorphic ciphertext, thereby making a dimension of the a-part of the second homomorphic ciphertext smaller than a dimension of the a-part of the first homomorphic ciphertext.

In addition, if the homomorphic ciphertext needs to be decrypted, the processor 120 may generate a polynomial-form decryption text (or plaintext) by applying the secret key to the homomorphic ciphertext, and may generate the message by decoding the polynomial-form decryption text. Here, the generated message may include the error as mentioned in Equation 1 above. The message generated in this way may be referred to as the plaintext, a decrypted ciphertext, or the like.

In addition, the processor 120 may perform the homomorphic operation (or general arithmetic operation) on the homomorphic ciphertext. In detail, the processor 120 may perform an operation, such as addition or multiplication, on the homomorphic ciphertext while maintaining its encrypted state. In detail, the processor 120 may process each homomorphic ciphertext to be used in the operation by using a first function, perform the operation, such as addition or multiplication, between the homomorphic ciphertexts processed using the first function, and process the homomorphic ciphertext on which the operation is performed by using a second function, which is an inverse function of the first function. The first function processing and the second function processing may utilize a linear transformation technique in the bootstrapping process described below.

In addition, the processor 120 may perform the bootstrapping operation on the ciphertext if the approximate message weight in the operation result ciphertext exceeds the threshold. In detail, the processor 120 may expand a modulus of the operation result ciphertext, perform a first linear transformation on the homomorphic ciphertext, whose modulus is expanded, into a polynomial form, perform an approximate operation on the first homomorphic ciphertext transformed into the polynomial form by using a function set to approximate a modulated range of the plaintext, and perform a second linear transformation on the second homomorphic ciphertext, on which the approximate operation is performed, into a form of the homomorphic ciphertext.

Meanwhile, the bootstrapping operation may be performed by separating a general bootstrapping process and an operation after the transformation (or compression).

As described above, the electronic apparatus 100 according to the disclosure may compress the homomorphic ciphertext, and thus may store more homomorphic ciphertext than in a conventional apparatus.

As described above, the electronic apparatus according to the disclosure may perform the transformation operation in a plurality of stages, and the RLWE ciphertext may thus have a smaller-dimensional a-part than in the conventional apparatus, thereby reducing a size of the homomorphic ciphertext.

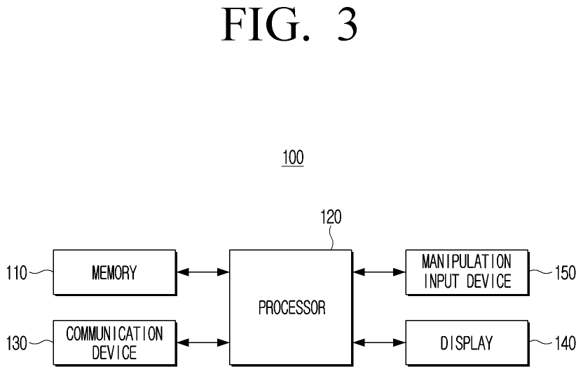

Meanwhile, hereinabove, only the brief components included in the electronic apparatus 100 are shown and describes. However, various additional components may be provided in implementation. This configuration is described below with reference to FIG. 3.

FIG. 3 is a block diagram showing a specific configuration of the electronic apparatus according to an embodiment of the disclosure.

Referring to FIG. 3, the electronic apparatus 100 according to the disclosure may include the memory 110, the processor 120, a communication device 130, a display 140, and a manipulation input device 150.

The description describes the memory 110 with reference to FIG. 2, and thus omits its redundant description. In addition, the description also describes the processor 120 with reference to FIG. 2, and omits its contents provided with reference to FIG. 2, and only describes its functions added in FIG. 3.

The communication device 130 may connect the electronic apparatus 100 to the external device (not shown), and may be connected to the external device not only via a local area network (LAN) or the internet, but also via a universal serial bus (USB) port or a wireless communication port (e.g., Wi-Fi 802.11a/b/g/n, NFC, or Bluetooth). The communication device 130 may also be referred to as a transceiver.

The communication device 130 may receive the public key from the external device, and transmit the public key generated by the electronic apparatus 100 to the external device.

In addition, the communication device 130 may receive the message from the external device, and transmit the generated homomorphic ciphertext to the external device. On the other hand, the communication device 130 may also receive the ciphertext from the external device.

In addition, the communication device 130 may receive various parameters required for generating the ciphertext from the external device. Meanwhile, in implementation, the various parameters may be input directly from the user through the manipulation input device 150 described below.

In addition, the communication device 130 may receive the pre-trained model from an external source or the weight matrix included in the above-described model.

The display 140 may display a user interface window for selection of functions supported by the electronic apparatus 100. In detail, the display 140 may display the user interface window for the selection of various functions provided by the electronic apparatus 100. The display 140 may be a monitor such as a liquid crystal display (LCD), a cathode ray tube (CRT), or an organic light-emitting diode (OLED), and may also be implemented as a touchscreen capable of simultaneously performing a function of the manipulation input device 150 described below.

The display 140 may display a message requesting input of the parameter required for generating the secret key or the public key. In addition, the display 140 may display a message for selecting a message which is the encryption target. Meanwhile, in implementation, the encryption target may be selected directly by the user or automatically selected. That is, the personal information or the like that requires the encryption may be set automatically even if the user does not directly select the message.

The manipulation input device 150 may receive a function selection command and a control command for a corresponding function of the electronic apparatus 100 from the user. In detail, the manipulation input device 150 may receive the parameter required for generating the secret key or the public key from the user. In addition, the manipulation input device 150 may receive the message to be encrypted from the user.

In addition, the manipulation input device 150 may receive a selection of the learning model to be applied to the plurality of homomorphic ciphertexts. Based on such a selection command, the processor 120 may perform the matrix operation between the plurality of homomorphic ciphertexts and the weight matrix included in the selected learning model.

In addition, the manipulation input device 150 may also receive a transmission command, a homomorphic operation command, or the like for the homomorphic ciphertext.

If the processor 120 receives the parameters required for generating the secret key or the public key from the user, the processor 120 may generate a setting parameter based on the received parameter, and generate the secret key or the public key based on the generated setting parameter.

In addition, if it is necessary to generate the ciphertext for the message, the processor 120 may generate the homomorphic ciphertext by applying the public key to the message. In detail, the processor 120 may generate the homomorphic ciphertext by transforming the message into the polynomial form and applying the public key to the message transformed into the polynomial form.

In addition, if it is necessary to decrypt the homomorphic ciphertext, the processor 120 may apply the secret key to the homomorphic ciphertext to thus generate the polynomial-form decryption text, and decode the polynomial-form decryption text to thus generate the message. Here, the generated message may include the error as mentioned in Equation 1 above.

In addition, if it is necessary to perform the operation on the homomorphic ciphertext, the processor 120 may perform the addition or multiplication operation on the plurality of homomorphic ciphertexts requested by the user.

As described above, the electronic apparatus 100 according to this embodiment may generate the homomorphic ciphertext for the message, thus improving the stability of the message even if the operation is required. In addition, the generated homomorphic ciphertext may include the error, thus maintaining stable security even for biometric information or the like that requires high security.

Hereinafter, the description describes an operation for transforming the RLWE ciphertext into the MSRLWE ciphertext and an efficient bootstrapping operation on the ciphertext transformed into the MSRLWE ciphertext.

First, a main operation in the disclosure is to separate one ciphertext. Hereinafter, it is assumed that a matrix is square and has dimension d. In addition, q2 and N are powers of 2, and R_{q,N}=Zq[x]/(X^{N}+1) is defined as a ring learning with errors (RLWE) ring.

For example, the RLWE ciphertext may include the a-part and the b-part. For example, the RLWE ciphertext encrypted as ct=(a, b)∈R²_{q,N} by using a secret key s∈R_{N} may be decrypted as Dec(ct)=b+as=m.

The disclosure describes a method for reducing the size of the ciphertext by making the a-part in the homomorphic ciphertext as described above have a smaller dimension.

First, the multiple-secret RLWE ciphertext may use a shared a-part. In detail, the RLWE ciphertext may include pairs (a, b)∈R_{Q}² for the secret key sk∈R and a plaintext m∈R. Here, each ciphertext may be expressed by Equation 9 below.

$$a \cdot sk + b = m mod Q . \qquad [ Equation 9 ]$$

Here, a indicates the a-part and b indicates the b-part. In addition, sk indicates the secret key and m indicates a ring element.

As described above, the RLWE ciphertext may use two elements of Ro to represent a single ring element m, which may also affect computational performance.

If several ciphertexts use the common a-part, representation efficiency may be improved. This configuration shows that only k+1 R_{Q} elements are required to store k plaintexts.

In other words, if k b-parts share one a-part, k may be a secret rank of this ciphertext. RLWEₙ=MSRLWEₙ⁽¹⁾ if the MSRLWE ciphertext having degree n and secret rank k is represented as MSRLWEₙ^{(k)}.

However, a conventional transformation process for this transformation has several problems. In detail, the above-described transformation process uses a switching key. However, a size of the switching key is proportional to the square of the secret rank k, and it is thus difficult to use the transformation for large k.

In detail, a binary modulus (binary modulus 2^{k}) and a high gadget rank decomposition are required to reduce the ciphertext to a very smaller dimension. For example, if it is required to use n=2¹² and hamming_weight=32, an allowed modulus is limited to only 32 bits. However, there is a difficulty in that 31 bits (=2³¹) are required as a quantize modulus and 2 as a temporary modulus to generate a key having gadget rank 31.

In the disclosure, this problem is solved by making the size of the switching key proportional to k, and the transformation may thus be used even for relatively large k.

In detail, in case of comparing a conventional scheme with the scheme in the disclosure, the transformation in the conventional scheme is performed in a single stage, whereas the scheme in the disclosure may be referred to as a synthesis of several auxiliary stages. That is, in the disclosure, the secret rank is gradually increased and the a-part is reduced at each stage. That is, a process of receiving RLWE ciphertext k=k₀k₁ . . . kᵣ₋₁ and converting the same into one MSRLWE^{(k)} may include r auxiliary stages.

$$k \cdot {RLWE}_{n} \to ( {k}_{1} … {k}_{r - 1} ) \cdot {MSRLWE}_{n}^{{k}_{0}} \to … \to ( {k}_{r - 1} ) \cdot {MSRLWE}_{n}^{{k}_{0} … {k}_{r - 2}} \to {MSRLWE}_{n}^{k} . \qquad [ Equation 10 ]$$

For example, if the conventional scheme needs to reduce 16 ciphertexts into one, the 16 RLWE ciphertexts are conventionally converted into one MSRLWE through a single process (or operation). On the other hand, in the disclosure, the stages may proceed with a first process for converting 16 RLWE ciphertexts into 8 MSRLWE ciphertexts, a second process for converting 8 MSRLWE ciphertexts into 4 MSRLWE ciphertexts, a third process for converting 4 MSRLWE ciphertexts into 2 MSRLWE ciphertexts, and a fourth process for converting 2 MSRLWE ciphertexts into one MSRLWE ciphertext.

Here, the secret rank may increase by kⱼ times for each auxiliary stage, and a total number of a-parts may decrease by kⱼ times. The switching key for executing the auxiliary stage is as follows.

$$s w {k}_{Q , P , {\{ {sk}_{i} \}}_{0 < i < t} \to {\{ {sk}_{j}^{′} \}}_{0 < j < lt}} = ( a = ( \begin{matrix}\begin{matrix}\begin{matrix}{a}_{0} \\ {a}_{1}\end{matrix} \\ ⋮\end{matrix} \\ {a}_{l - 1}\end{matrix} ) , B ) . \qquad [ Equation 11 ]$$

$$B = - ( \begin{matrix}\begin{matrix}\begin{matrix}{a}_{0} \\ {a}_{1}\end{matrix} \\ ⋮\end{matrix} \\ {a}_{l - 1}\end{matrix} ) \cdot ( {sk}_{0}^{′} , … , {sk}_{l - 1}^{′} ) + P \cdot ( \begin{matrix}s k & 0 & ⋯ & 0 \\ 0 & s k & ⋯ & 0 \\ ⋮ & ⋮ & ⋱ & ⋮ \\ 0 & ⋯ & 0 & s k\end{matrix} ) . \qquad Equation 12 ]$$

Here, sk=(sk₀, . . . , skₜ₋₁), Q indicates the modulus (or a multiple of the modulus) of the homomorphic ciphertext to be transformed, P indicates a modulus temporarily used for the precision of key switching, skᵢ∈Rₙ indicates a secret key of the input MSRLWE ciphertext, sk′ⱼ∈Rₙ indicates a secret key of the output MSRLWE ciphertext. In addition, aᵢ∈R_{QP,n}, B∈R_{QP,n}^{2×2t}.

If the input ciphertexts in the auxiliary stage l·MSRLWEₙ^{(t)}→MSRLWEₙ^{(lr)} are given as (α₀, β₀=(β₀₀, . . . , β_{0,t-1})) and (α₁, β₁=(β₁₀, . . . , β_{1,t-1})), the a-part and the b-part of the output MSRLWE ciphertext may be computed as follows, respectively.

$${α}^{′} = ⌊ \frac{1}{P} ( < {( {α}_{0} , {α}_{1} , … , {α}_{ℓ - 1} )}^{T} , a > mod PQ ) ⌉ . \qquad [ Equation 13 ]$$

$${β}^{′} = ( {β}_{0} , {β}_{1} , … , {β}_{ℓ - 1} ) + ⌊ \frac{1}{P} ( < ( {α}_{0} , {α}_{1} , … , {α}_{ℓ - 1} ) \cdot B mod PQ ) ⌉ . \qquad [ Equation 14 ]$$

For example,

$$B = ( \begin{matrix}{a}_{0} \\ {a}_{1}\end{matrix} ) \cdot ( {sk}_{0}^{′} , {sk}_{1}^{′} ) + P \cdot ( \begin{matrix}{sk}_{0} & 0 \\ 0 & {sk}_{0}\end{matrix} )$$

if t=1 and [symbol] =2. Accordingly, the output ciphertext is (α′, β′=(−α′sk′₀+m₀, −α′sk′₁+m₁) if the input ciphertexts are (α₀, β₀=−α₀sk₀+m₀) and (α₁, β₁=−α₁sk₁+m₁).

Hereinabove, the description describes the process of transforming the plurality of homomorphic ciphertexts into one ciphertext. The description above describes the operation performed in the process of merging the plurality of ciphertexts into one ciphertext. However, in implementation, a size of one ciphertext may also be reduced by applying the operation described above to one ciphertext. This configuration is described below.

Hereinafter, the description describes a method for transforming input ciphertext (aᵢₙ, bᵢₙ)∈R²_{Q,N} into (aᵣₑₛ, bᵣₑₛ)∈R_{Q,n}×R_{Q,N}. Here n≤N may be a natural number.

It is assumed that a secret key of the input ciphertext is skᵢₙ∈R_{Q,N}, and an secret key of the output ciphertext is skᵣₑₛ∈R_{Q,n}.

First, key switching skᵢₙ→skᵣₑₛ may be performed on (aᵢₙ, bᵢₙ). Assuming that a result of the key switching is (a₁, b₁), (a₁, b₁) may be expressed as N/n ciphertexts (a_{1,j}, b_{1,j})∈R²_{Q,n} on R_{Q,n} because R_{Q,N} is an R_{Q,n}-module of rank N/n.

In addition, N/n·RLWEₙ→MSRLWE^{(N/n)}ₙ as described above may be applied to (a_{1,j}, b_{1,j}). Assume that a result of this process is (a₂, b_{2,0}, b_{2,1}, . . . , b_{2,N/n-1}).

Here, (aᵣₑₛ, bᵣₑₛ)∈R_{Q,n}×R_{Q,N} if aᵣₑₛ=a₂ and

$${b}_{r e s} − {\sum }_{j = 0}^{N / n - 1} {b}_{2 , j} {X}^{j}$$

(where, X is X in R_{Q,N}=Z_{Q}[X]/(X^{N}+1)).

In this way, the a-part of the homomorphic ciphertext is sparse, it is thus possible to perform lower-dimension number theoretic transform (NTT) during modulus expansion (ModUp) and inner-product with the switching key, and to keep only a smaller amount of information (limited to a first radix). In an actual implementation, a result of to-sparse-a is several MSRLWE ciphertexts each having degree=n, it is thus possible to perform modulus size increase (ModRaise) as it is.

Meanwhile, the bootstrapping may be performed on the homomorphic ciphertext transformed in this way, and the bootstrapping operation may be partially modified as follows based on a property of the transformed homomorphic ciphertext, that is, the ciphertext sharing the a-part.

In detail, the description describes a method for improving a first matrix multiplication of coeffToSlot in a bootstrapping process for the homomorphic ciphertext to which the transformation process described above is applied. Here, the matrix multiplication may include not only the multiplication between matrices having a plurality of columns or a plurality of rows, but also the multiplication between one matrix and a vector.

In general, coeffToSlot indicates a process of transforming a ciphertext in a format where data is encoded in the coefficients of a polynomial into a ciphertext in a format where data is encoded in slots. That is, coeffToSlot may be viewed as a process of multiplying a ciphertext by a matrix, and for efficient computation, this matrix may be divided into several parts and the multiplication operation may be performed.

Among these divided matrix parts, the first matrix multiplication may be performed immediately after the ModRaise process, and the following improvements may thus be applied.

First, a first improvement is to couple ModUp and ModRaise. The ModUp process during the key switching process performed in the first matrix multiplication of coeffToSlot is essentially the same process as ModRaise. Therefore, instead of performing both the processes, only one process may be performed. That is, ModRaise may be performed, the switching key may then be multiplied immediately, and modulus reduction (ModDown) may then be performed.

A second improvement is to perform a lazy b-part mod raise operation. For example, the ciphertext at a bottom level (in a state immediately before ModRaise is performed) during the bootstrapping process has a low modulus. Here, ModRaise needs to be performed on the a-part for the key switching, whereas the matrix multiplication may be performed on the b-part while maintaining its low level, and ModRaise may then be performed on the b-part.

For example, b+as=m+q₀I if a ciphertext (ct=(b, a)) at level zero is given.

If diagonals d₀, . . . dᵣ₋₁ encoded using the appropriate scaling factor are given, the first radix of C2S without using bs-gs may be computed as follows.

$${a}_{1} = {\sum }_{j} [ a ] {Q}_{p 0 P 1}^{( j )} \cdot {swk}_{j} \cdot {d}_{j} , {b}_{1} = {\sum }_{j} [ b ] {Q}_{p 0}^{( j )} \cdot {d}_{j} . \qquad [ Equation 15 ]$$

Scaling a result of Equation 15 gives the following.

$${a}_{2} = ⌊ \frac{1}{{p}_{0} {p}_{1}} {a}_{1} ⌉ , {b}_{2} = ⌊ \frac{1}{{p}_{0}} {b}_{1} ⌉ . \qquad [ Equation 16 ]$$

Meanwhile,

$${a}_{2} + {b}_{2} = Enc ( {\sum }_{j} \frac{{( m \text{?} {q}_{0} \text{?} )}^{( j )} {d}_{j}}{{p}_{0}} )$$

$$\text{?} \text{indicates text missing or illegible when filed}$$

because

$${{a}_{2} [ Enc ( {\sum }_{j} \begin{matrix}{a}^{( j )} {s}^{( j )} {d}_{j} \\ {p}_{0}\end{matrix} ) ⌉}_{ξ}$$

$$and$$

$${b}_{2} = − {\sum }_{j} \frac{{a}^{( j )} {s}^{( j )} {d}_{j}}{{p}_{0}} \text{?} {\sum }_{j} \frac{{( m + {q}_{0} I )}^{( j )} {d}_{j}}{{p}_{0}} .$$

$$\text{?} \text{indicates text missing or illegible when filed}$$

Here, b₂ is equivalent to processing with integer computation. Therefore, it is sufficient to perform ModRaise on the b-part only to a level where overflow does not occur, and then compute the b-part.

To summarize these operations, the linear transformation, i.e., coeffToSlot, may be described as the following operation. The operation described below assumes the following conditions. It is assumed that the input ciphertext (aᵢₙ, bᵢₙ) has coefficient encoded at the bottom level (or low level). The following description covers up to the first matrix multiplication of coeffToSlot. A subsequent process may be performed in the same way as in the existing bootstrapping scheme. In addition, q₀ indicates the modulus of the input ciphertext, Q indicates the modulus of the output ciphertext, and pₐ and p_{b} indicate the temporary moduli.

The first matrix multiplication of coeffToSlot is expressed as

$${\sum }_{j = 0}^{k / 2 − 1} {m}^{jN / k} {d}_{j} .$$

Here, m∈R_{N} indicates the encrypted polynomial in the input ciphertext, and m^{(t)}(X)=m(X⁵^{^{t}}) indicates its rotation by index t.

1. sparse-format-switch is used to transform (aᵢₙ, bᵢₙ) into (a₁, b₁)=R_{q0,n}×R_{q0,N}. Here, the secret key of (a₁, b₁) is s₁∈R_{N}.

$$2. \qquad ( {a}_{2} , {b}_{2} ) = mod {Down}_{{Q}_{p} \to Q} \text{?} ( {\sum }_{j = 0}^{nk / 2 N - 1} {mod}_{e} {UP}_{{q}_{0} \to {Q}_{p}} \text{?} ( {a}_{1}^{( jN / k )} ) s w {k}_{j} ) .$$

$$\text{?} \text{indicates text missing or illegible when filed}$$

### Here,

$$s w {k}_{j} = E n {c}_{{Q}_{p} , {s}_{res} \text{?}} ( {\sum }_{l = 0}^{N / n - 1} {s}_{1}^{( jN / k + lN / 2 )} {d}_{j {+}_{\frac{lnk}{2 n}}} )$$

$$\text{?} \text{indicates text missing or illegible when filed}$$

indicates the switching key.

3. In addition,

$${b}_{3} = mod {Down}_{{q}_{0} {p}_{b} \to {q}_{0}} ( {\sum }_{{j = 0}^{}}^{k / 21} {( mod Up ( {b}_{1} ) )}^{( jN / k )} {d}_{j} ) .$$

4. (aᵣₑₛ, bᵣₑₛ)=(a₂, b₂+modU_{pq0→Q}(b₃)) indicates the output ciphertext.

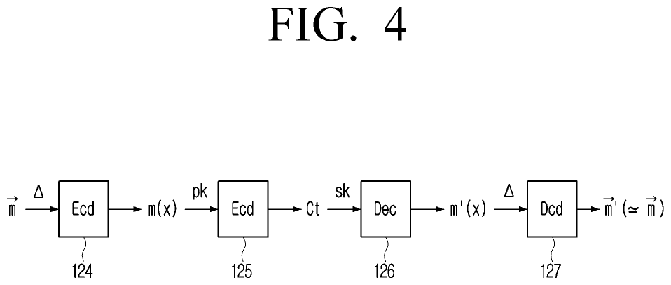

FIG. 4 is a diagram for describing the generation and decryption operations of an approximate homomorphic ciphertext.

Referring to FIG. 4, an encoding module 124 may receive the message and the scaling factor, and transform the message into the polynomial form by reflecting the scaling factor.

In detail, the encoding module 124 may output the message into a polynomial as shown in Equation 17 below if the encoding module 124 receives the message in the polynomial form and the scaling factor equal to or greater than one.

$${m ( X ) = {ϒ}^{- 1} ( ⌊ Δ \cdot \vec{m} ⌉}_{ϒ ( {R}^{′} )} ) ∈ {R}^{′} . \qquad [ Equation 17 ]$$

Here, m(x) indicates the message in the polynomial form, R indicates the ring, and Δ indicates the scaling factor. This format transformation may be referred to as the linear transformation.

In addition, an encryption module 125 may receive the message in the polynomial form, and generate the homomorphic ciphertext by reflecting the public key to the received message. In detail, the encryption module 125 may generate the homomorphic ciphertext by using Expression 18 below.

$$υ \cdot p k + ( m + {e}_{0} , {e}_{1} ) ( mod {q}_{L} ) . \qquad [ Equation 18 ]$$

Here, ν indicates a selected element, e₀ and e₁ indicate selected errors values, and q_{L} indicates the modulus.

Meanwhile, in implementation, only a partial region in Equation 19 above may be generated, that is, a ciphertext in the form of Equation 19 below may be used.

$$b = - < \vec{a} , \vec{s} + m + e = ( - {a}_{0} {s}_{0} + … + - {a}_{k - 1} {s}_{k - 1} ) + m + e . \qquad [ Equation 19 ]$$

Here, ŝ=(s₀, . . . , sₖ₋₁) indicates the secret key, m indicates the message, and e indicates the error.

A decryption module 126 may receive the ciphertext and the secret key, decrypt the ciphertext, and output the message including the error. The operation by the decryption module may be performed in a manner corresponding to a corresponding scheme in the same manner as the encryption method.

Meanwhile, the message output by the decryption module 126 is the message in the polynomial form, and a decoding module 127 may output a final message based on the message output by the decryption module 126 and the scaling factor.

FIG. 5 is a diagram for describing the bootstrapping operation in the disclosure. In detail, FIG. 5 shows the operation and bootstrapping process for two homomorphic ciphertexts 10 and 20. The term “bootstrapping” may also be expressed as the bootstrapping operation, a plaintext space expansion, or the like.

The homomorphic ciphertexts 10 and 20 may include approximate message regions 11 and 21, respectively. The approximate message regions 11 and 21 may contain the message and an error (m1+e1, m2+e2).

An electronic apparatus 100 may perform a specific operation by using the two homomorphic ciphertexts 10 and 20 as input values. Here, the specific operation may be not only an arithmetic operation, a polynomial operation, or the like on the two ciphertexts, but also a non-polynomial operation such as a comparison operation. The non-polynomial operation on the ciphertext may be performed using an approximate polynomial corresponding to the non-polynomial operation.

An operation result ciphertext 30 may include an approximate message region 31 containing an operation result (m₃+e₃) between the respective approximate messages. As the operation result becomes larger than the input value, the approximate message region may also become larger, and a remaining plaintext space 32 may thus decrease. If this operation is performed several times, the remaining plaintext space 32 may eventually disappear or become smaller than a limit, thus making further operations impossible. If it is determined that the ciphertext is in this state, the electronic apparatus 400 may perform the bootstrapping operation.

It may be seen that in a ciphertext 40 on which the bootstrapping is performed, an approximate message region 41 is constant/predetermined, and a plaintext space 42 is expanded.

Meanwhile, this bootstrapping scheme may not only expand the plaintext space, but also modify the modulus during the process. Meanwhile, this bootstrapping scheme may be performed not only immediately after the operation processing described above, but also after various operation processing such as the format transformation. More detailed operation of the bootstrapping scheme is described below with reference to FIG. 6.

FIG. 6 is a diagram for describing the detailed operation of the bootstrapping operation. In detail, FIG. 6 shows the bootstrapping operation using polynomial approximation (EvalMod), and expresses each operation in the polynomial form and the ciphertext state.

General bootstrapping may be performed sequentially in the following order: 1) a step for expanding the modulus (ModRaise) (S10), 2) an operation for changing a range of the homomorphic ciphertext to a range applied by an approximation algorithm (CoeffToSlot), an operation for applying the approximation algorithm (EvalMod) (S20), and 3) an operation for restoring the range (SlotToCoeff) (S30). As described above, this general scheme may be used if the plaintext space is insufficient.

On the other hand, in the case where the first-scheme homomorphic ciphertext is transformed into the second-scheme homomorphic ciphertext as described above, the linear transformation operation described above may be applied after partial modification. Specifically, as described above, the ModUp operation in the CoeeffToSlot step may be omitted, or the ModRaise operation may be performed after performing the matrix multiplication on the b-part.

In this way, a part of the conventional bootstrapping operation may be modified to enable faster bootstrapping to be performed.

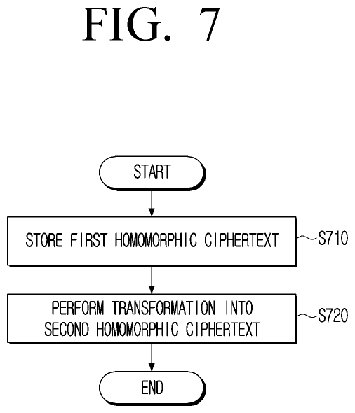

FIG. 7 is a flowchart for describing a method for processing a ciphertext according to an embodiment of the disclosure.

Referring to FIG. 7, the electronic apparatus may store the first homomorphic ciphertext encrypted using the first scheme (S710). Here, the first homomorphic ciphertext may be a ciphertext encrypted using the CKKS-scheme, and the corresponding ciphertext may include the a-part and the b-part. In addition, the first-scheme homomorphic ciphertext may be the plurality of homomorphic ciphertexts, each of which has the different values for the a-part and the b-part.

In addition, the electronic apparatus may transform the first homomorphic ciphertext into the second homomorphic ciphertext encrypted using the second scheme (S720). For example, the partial transformation operation for gradually increasing the rank of the secret key may be iterated multiple times to transform the first homomorphic ciphertext into the second homomorphic ciphertext.

The transformation may be classified into the first embodiment that transforms the plurality of first homomorphic ciphertexts into one second homomorphic ciphertext, and the second embodiment that transforms one first homomorphic ciphertext into the second homomorphic ciphertext.

First, in the first embodiment, one second homomorphic ciphertext may be generated from the plurality of first homomorphic ciphertexts by iterating the partial merging operation for increasing the rank of the merged homomorphic ciphertext by k times multiple times. Here, the partial transformation operation may be the partial merging operation for merging k homomorphic ciphertexts into one homomorphic ciphertext.

For example, in case of using two-time iterations, the fourth homomorphic ciphertext encrypted using the second scheme may be generated, in which some of the plurality of first homomorphic ciphertexts have the same a-part, and the fifth homomorphic ciphertext encrypted using the second scheme may be generated, in which that the others of the plurality of first homomorphic ciphertexts have the same a-part. In addition, the a-part of the second homomorphic ciphertext may be determined using the a-part of the fourth homomorphic ciphertext and the a-part of the fifth homomorphic ciphertext, and the b-part of the second homomorphic ciphertext may be generated based on the determined a-part of the second homomorphic ciphertext. Meanwhile, in the implementation, two or more repetitions may be used instead of two repetitions.

Meanwhile, in the second embodiment, the partial merging operation described above may be performed in the process of transforming one first homomorphic ciphertext into one second homomorphic ciphertext, thereby making the dimension of the a-part of the second homomorphic ciphertext smaller than the dimension of the a-part of the first homomorphic ciphertext.

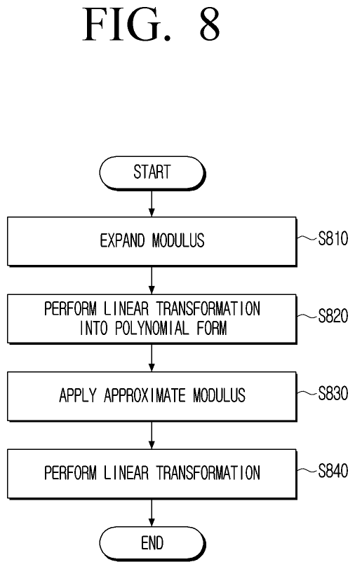

Meanwhile, after the aforementioned operation is performed, the bootstrapping operation may be performed. This configuration is described below with reference to FIG. 8.

In this way, the transformation operation may be performed in the plurality of stages, and the RLWE ciphertext may thus have the smaller-dimensional a-part than in the conventional case, thereby reducing the size of the homomorphic ciphertext.

FIG. 8 is a flowchart for describing the bootstrapping operation according to an embodiment of the disclosure.

Referring to FIG. 8, the electronic apparatus may expand the modulus of the homomorphic ciphertext (S810). For example, the electronic apparatus may perform the modulus expansion operation on the a-part of the second homomorphic ciphertext before performing the matrix multiplication, and perform the modulus expansion operation on the b-part of the second homomorphic ciphertext after performing the matrix multiplication.

In detail, the ciphertext at the bottom level (i.e., immediately before ModRaise) during the bootstrapping process may have the low modulus. That is, as shown in FIG. 7, the ciphertext may have the low modulus immediately after the first homomorphic ciphertext is transformed into the second homomorphic ciphertext. Therefore, the a-part of the second homomorphic ciphertext needs to be ModRaised for the key switching. However, the b-part may be ModRaised after the matrix multiplication. That is, ModRaise may be performed on the b-part after the matrix multiplication instead of before the matrix multiplication.

In addition, the electronic apparatus may perform the first linear transformation on the homomorphic ciphertext, whose modulus is expanded, into the polynomial form (S820). In detail, the electronic apparatus may linearly transform each coefficient of the polynomial into a form in which the coefficient is mapped into the slot by using a predefined matrix. Here, the predefined matrix may perform the linear transformation having a lower precision than the matrix used in the ciphertext generation process for the homomorphic ciphertext.

Conventionally, the ModUp operation is performed during the CoeffToSlot process. However, the ModUp operation during this process is the same process as the modulus expansion in step S810 above. Therefore, the two processes may be combined to perform the modulus operation only one time. That is, only one modulus expansion operation may be performed, and the operation for multiplying the switching key and ModDown may be performed immediately.

Meanwhile, hereinabove, the transformation using the second linear transformation operation compared to the conventional case is shown and described. However, in other words, in the disclosure, the conventional modulus expansion (ModRaise) and ModUp operations in the CoeffToSlot process are combined into one process. Therefore, it may be expressed that the CoeeffToSlot process is performed instead of the operation at S810.

In addition, the electronic apparatus may perform the approximate operation on the homomorphic ciphertext transformed into the polynomial form by using the function set to approximate the modulated range of the plaintext (S830). Here, the set function may be a step function or a function satisfying a weighted Remez algorithm using the step function as a weight. In detail, this function may be defined as a difference between the homomorphic ciphertext transformed into the polynomial form and a polynomial equation set to approximate the input values of the ciphertext transformed into the polynomial form within a predetermined range to integer points.

In addition, the electronic apparatus may perform the second linear transformation on the homomorphic ciphertext, on which the approximate operated is performed, into the form of the homomorphic ciphertext (S840). Here, the electronic apparatus may perform the second linear transformation in the form of the homomorphic ciphertext by reflecting the scaling factor. Here, the scaling factor may have a different value from the scale factor used in the first linear transformation.

In this way, the electronic apparatus may efficiently perform the conventional bootstrapping operation, that is, may omit the functions (e.g., ModRaise and ModUp) that are conventionally performed redundantly, and consider the modulus level at each state, thereby performing more efficient and faster bootstrapping operation.

A device including the non-transitory readable medium may perform the operation such as public key generation, encryption, or decryption, as described in the various embodiments described above.

The term “non-transitory” indicates that the storage medium is tangible without including a signal, and does not distinguish whether data are semi-permanently or temporarily stored on the storage medium.

Alternatively, a program for performing the method according to the various embodiments described above may be distributed online via an application store. In case of the online distribution, at least portions of the computer program product may be at least temporarily stored on a storage medium such as the memory of a server of a manufacturer, a server of an application store or a relay server, or be temporarily generated.

Each of the components (for example, modules or programs) according to the various embodiments may include a single entity or a plurality of entities, and some of the corresponding sub-components described above may be omitted or other sub-components may be further included in the various embodiments. Alternatively or additionally, some of the components (for example, the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the embodiments of the disclosure are shown and described as above, the disclosure is not limited to the above-mentioned specific embodiments, and may be variously modified by those skilled in the art to which the disclosure pertains without departing from the gist of the disclosure as claimed in the accompanying claims. These modifications should also be understood to fall within the scope and spirit of the disclosure.

What is claimed is:

1. An electronic apparatus comprising:
a memory for storing an instruction; and
a processor configured to execute the instruction to thus transform a first homomorphic ciphertext homomorphically encrypted using a first scheme into a second homomorphic ciphertext encrypted using a second scheme,
wherein each of the first homomorphic ciphertext and the second homomorphic ciphertext includes an a-part and a b-part,
the first scheme is a homomorphic ciphertext format in which a plurality of homomorphic ciphertexts have different a-parts and b-parts,
the second scheme is a homomorphic ciphertext format in which a plurality of homomorphic ciphertexts have the same a-part and only different b-parts, and
the processor is configured to transform the first homomorphic ciphertext into the second homomorphic ciphertext by iterating a partial transformation operation of gradually increasing a rank of a secret key multiple times.

2. The apparatus as claimed in claim 1, wherein the processor is configured to transform the plurality of first homomorphic ciphertexts into one second homomorphic ciphertext.

3. The apparatus as claimed in claim 2, wherein the processor is configured to:
generate a fourth homomorphic ciphertext encrypted using the second scheme, in which some of the plurality of first homomorphic ciphertexts have the same a-part,
generate a fifth homomorphic ciphertext encrypted using the second scheme, in which the others of the plurality of first homomorphic ciphertexts have the same a-part,
determine the a-part of the second homomorphic ciphertext by using the a-part of the fourth homomorphic ciphertext and the a-part of the fifth homomorphic ciphertext, and generate the b-part of the second homomorphic ciphertext based on the determined a-part of the second homomorphic ciphertext.

4. The apparatus as claimed in claim 2, wherein the partial transformation operation is a partial merging operation for merging k homomorphic ciphertexts into one homomorphic ciphertext, and
the processor is configured to generate the one second homomorphic ciphertext from the plurality of first homomorphic ciphertexts by iterating the partial merging operation for increasing a rank of the merged homomorphic ciphertext by k times multiple times.

5. The apparatus as claimed in claim 1, wherein the processor is configured to transform one first homomorphic ciphertext into one second homomorphic ciphertext, and
a dimension of the a-part of the second homomorphic ciphertext is smaller than a dimension of the a-part of the first homomorphic ciphertext.

6. The apparatus as claimed in claim 1, wherein the processor is configured to:
expand a modulus of the homomorphic ciphertext,
perform a first linear transformation on the homomorphic ciphertext, whose modulus is expanded, into a polynomial form,
perform an approximate operation on the homomorphic ciphertext transformed into the polynomial form by using a function set to approximate a modulated range of a plaintext, and
perform a second linear transformation on the homomorphic ciphertext, on which the approximate operation is performed, into a form of the homomorphic ciphertext to perform bootstrapping on the homomorphic ciphertext.

7. The apparatus as claimed in claim 6, wherein the processor is configured to:
perform a modulus expansion operation on the homomorphic ciphertext whose modulus is expanded in the first linear transformation process for the first homomorphic ciphertext, and
omit the modulus expansion operation from the first linear transformation process for the second homomorphic ciphertext.

8. The apparatus as claimed in claim 7, wherein the processor is configured to:
perform the modulus expansion operation on the a-part of the second homomorphic ciphertext before performing matrix multiplication, and
perform the modulus expansion operation on the b-part of the second homomorphic ciphertext after performing the matrix multiplication.

9. A method for processing a ciphertext by an electronic apparatus, the method comprising:
storing a first homomorphic ciphertext homomorphically encrypted using a first scheme; and
transforming the first homomorphic ciphertext into a second homomorphic ciphertext encrypted using a second scheme,
wherein each of the first homomorphic ciphertext and the second homomorphic ciphertext includes an a-part and a b-part,
the first scheme is a homomorphic ciphertext format in which a plurality of homomorphic ciphertexts have different a-parts and b-parts,
the second scheme is a homomorphic ciphertext format in which a plurality of homomorphic ciphertexts have the same a-part and only different b-parts, and
in the transforming, the first homomorphic ciphertext is transformed into the second homomorphic ciphertext by iterating a partial transformation operation of gradually increasing a rank of a secret key multiple times.

10. The method as claimed in claim 9, wherein in the transforming, the plurality of first homomorphic ciphertexts are transformed into one second homomorphic ciphertext.

11. The method as claimed in claim 10, wherein the transforming includes
generating a fourth homomorphic ciphertext encrypted using the second scheme, in which some of the plurality of first homomorphic ciphertexts have the same a-part, and generating a fifth homomorphic ciphertext encrypted using the second scheme, in which the others of the plurality of first homomorphic ciphertexts have the same a-part, and
determining the a-part of the second homomorphic ciphertext by using the a-part of the fourth homomorphic ciphertext and the a-part of the fifth homomorphic ciphertext, and generating the b-part of the second homomorphic ciphertext based on the determined a-part of the second homomorphic ciphertext.

12. The method as claimed in claim 10, wherein the partial transformation operation is a partial merging operation for merging k homomorphic ciphertexts into one homomorphic ciphertext, and
in the transforming, the one second homomorphic ciphertext is generated from the plurality of first homomorphic ciphertexts by iterating the partial merging operation for increasing a rank of the merged homomorphic ciphertext by k times multiple times.

13. The method as claimed in claim 9, wherein in the transforming, one first homomorphic ciphertext is transformed into one second homomorphic ciphertext, and
a dimension of the a-part of the second homomorphic ciphertext is smaller than a dimension of the a-part of the first homomorphic ciphertext.

14. The method as claimed in claim 9, further comprising:
expanding a modulus of the homomorphic ciphertext;
performing a first linear transformation on the homomorphic ciphertext, whose modulus is expanded, into a polynomial form;
performing an approximate operation on the homomorphic ciphertext transformed into the polynomial form by using a function set to approximate a modulated range of a plaintext; and
performing a second linear transformation on the homomorphic ciphertext, on which the approximate operation is performed, into a form of the homomorphic ciphertext.

15. The method as claimed in claim 14, wherein in the performing of the first linear transformation,
a modulus expansion operation on the homomorphic ciphertext whose modulus is expanded is performed for the first homomorphic ciphertext, and
the modulus expansion operation is omitted for the second homomorphic ciphertext.

16. The method as claimed in claim 15, wherein in the expanding of the modulus,
the modulus expansion operation is performed on the a-part of the second homomorphic ciphertext before matrix multiplication, and
the modulus expansion operation is performed on the b-part of the second homomorphic ciphertext after the matrix multiplication.

17. A non-transitory computer-readable recording medium including a program for executing a method for processing a ciphertext, wherein the method includes
storing a first homomorphic ciphertext homomorphically encrypted using a first scheme, and
transforming the first homomorphic ciphertext into a second homomorphic ciphertext encrypted using a second scheme,
wherein each of the first homomorphic ciphertext and the second homomorphic ciphertext includes an a-part and a b-part,
the first scheme is a homomorphic ciphertext format in which a plurality of homomorphic ciphertexts have different a-parts and b-parts,
the second scheme is a homomorphic ciphertext format in which a plurality of homomorphic ciphertexts have the same a-part and only different b-parts, and
in the transforming, the first homomorphic ciphertext is transformed into the second homomorphic ciphertext by iterating a partial transformation operation of gradually increasing a rank of a secret key multiple times.
